(19) United States
(12) Patent Application Publication
(10) Pub. No.: US 2018/0331730 A1
(43) Pub. Date: Nov. 15, 2018

(54) TECHNIQUE FOR BI-STATIC RADAR OPERATION SIMULTANEOUSLY WITH AN ACTIVE MMWAVE LINK

(71) Applicant: QUALCOMM Incorporated, San Diego, CA (US)

(72) Inventors: Amichai SANDEROVICH, Atlit (IL); Assaf Yaakov KASHER, Haifa (IL); Simha SORIN, Zoran (IL)

(21) Appl. No.: 15/972,782

(22) Filed: May 7, 2018

Related U.S. Application Data
(60) Provisional application No. 62/503,509, filed on May 9, 2017.

(51) Int. Cl. H04B 7/0417; H04B 7/06

(52) U.S. Cl. CPC H04B 7/0417; H04B 7/0617

(57) ABSTRACT

Certain aspects of the present disclosure provide methods and apparatus for performing radar operations. For example, certain aspects provide an apparatus having a first interface configured to output at least one first sequence for transmission in one or more directions, and a second interface configured to obtain at least one second sequence and at least one third sequence, where the at least one second sequence is obtained during the transmission of the at least one first sequence. In certain aspects, the apparatus also include a processing system configured to compare the at least one first sequence with the at least one second sequence, and detect one or more objects based on the comparison, wherein the detection of the one or more objects is further based on the at least one third sequence.

### CROSS-REFERENCE TO RELATED APPLICATIONS

This application claims benefit of U.S. Provisional Patent Application Ser. No. 62/503,509, filed May 9, 2017, which is expressly incorporated herein by reference in its entirety.

### FIELD

Certain aspects of the present disclosure generally relate to wireless communications and, more particularly, to performing radar operations.

### BACKGROUND

In order to address the issue of increasing bandwidth requirements demanded for wireless communications systems, different schemes are being developed to allow multiple user terminals to communicate with a single access point by sharing the channel resources while achieving high data throughputs.

Amendment 802.11ad to the WLAN standard defines the MAC and PHY layers for very high throughput (VHT) in the 60 GHz range. Operations in the 60 GHz band allow the use of smaller antennas as compared to lower frequencies. However, as compared to operating in lower frequencies, radio waves around the 60 GHz band have high atmospheric attenuation and are subject to higher levels of absorption by atmospheric gases, rain, objects, and the like, resulting in higher free space loss. The higher free space loss can be compensated for by transmitting signals via many small antennas, for example arranged in a phased array.

Using a phased array, multiple antennas may be coordinated to form a coherent beam traveling in a desired direction (or beam), referred to as beamforming. An electrical field may be rotated to change this direction. The resulting transmission is polarized based on the electrical field. A receiver may also include antennas which can adapt to match or adapt to changing transmission polarity.

The procedure to adapt the transmit and receive antennas, referred to as beamforming training, may be performed initially to establish a link between devices and may also be performed periodically to maintain a quality link using the best transmit and receive beams. Unfortunately, beamforming training represents a significant amount of overhead, as the training time reduces data throughput. The amount of training time increases as the number of transmit and receive antennas increase, resulting in more beams to evaluate during training.

### SUMMARY

Certain aspects of the present disclosure provide an apparatus for wireless communications. The apparatus generally includes a first interface configured to output a at least one first sequence for transmission in one or more directions, a second interface configured to obtain at least one second sequence and at least one third sequence, wherein the at least one second sequence is obtained during the transmission of the at least one first sequence, and a processing system configured to compare the at least one first sequence with the at least one second sequence, and detect one or more objects based on the comparison, wherein the detection of the one or more objects is further based on the at least one third sequence.

Certain aspects of the present disclosure provide a method for wireless communication. The method generally includes outputting at least one first sequence for transmission in one or more directions, obtaining at least one second sequence and at least one third sequence, wherein the at least one second sequence is obtained during the transmission of the at least one first sequence, comparing the at least one first sequence with the at least one second sequence, and detecting one or more objects based on the comparison, wherein the detection of the one or more objects is further based on the at least one third sequence.

Certain aspects of the present disclosure provide an apparatus for wireless communications. The apparatus generally includes means for outputting at least one first sequence for transmission in one or more directions, means for obtaining at least one second sequence and at least one third sequence, wherein the at least one second sequence is obtained during the transmission of the at least one first sequence, means for comparing the at least one first sequence with the at least one second sequence, and means for detecting one or more objects based on the comparison, wherein the means for detecting is configured to detect of the one or more objects further based on the at least one third sequence.

Certain aspects of the present disclosure provide a computer-readable medium having instructions stored thereon for outputting at least one first sequence for transmission in one or more directions, obtaining at least one second sequence and at least one third sequence, wherein the at least one second sequence is obtained during the transmission of the at least one first sequence, comparing the at least one first sequence with the at least one second sequence, and detecting one or more objects based on the comparison, wherein the detection of the one or more objects is further based on the at least one third sequence.

Certain aspects of the present disclosure provide an apparatus for wireless communications. The apparatus generally includes at least first antenna array, at least one second antenna array, a first interface configured to output at least one first sequence for transmission in one or more directions via the first antenna array, a second interface configured to obtain at least one second sequence via the second antenna array and configured to obtain at least one third sequence, wherein the at least one second sequence is obtained during the transmission of the at least one first sequence, and a processing system configured to compare the at least one first sequence with the at least one second sequence, and detect one or more objects based on the comparison, wherein the processing system is further configured to detect the one or more objects based on the at least one third sequence.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 is a diagram illustrating signal propagation in an implementation of phased-array antennas, in accordance with certain aspects of the present disclosure.

FIG. 4 illustrates an example beamforming training procedure.

FIG. 5 illustrates example operations for performing wireless communication, in accordance with certain aspects of the present disclosure.

FIG. 5A illustrates example components capable of performing the operations shown in FIG. 5.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. The techniques described herein may be utilized in any type of applied to Single Carrier (SC) and SC-MIMO systems.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

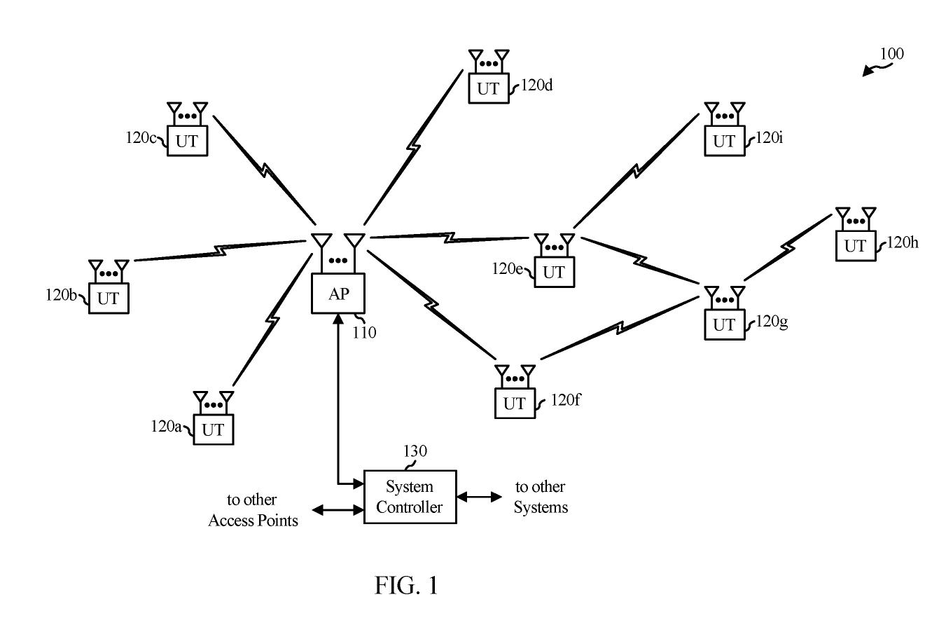

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

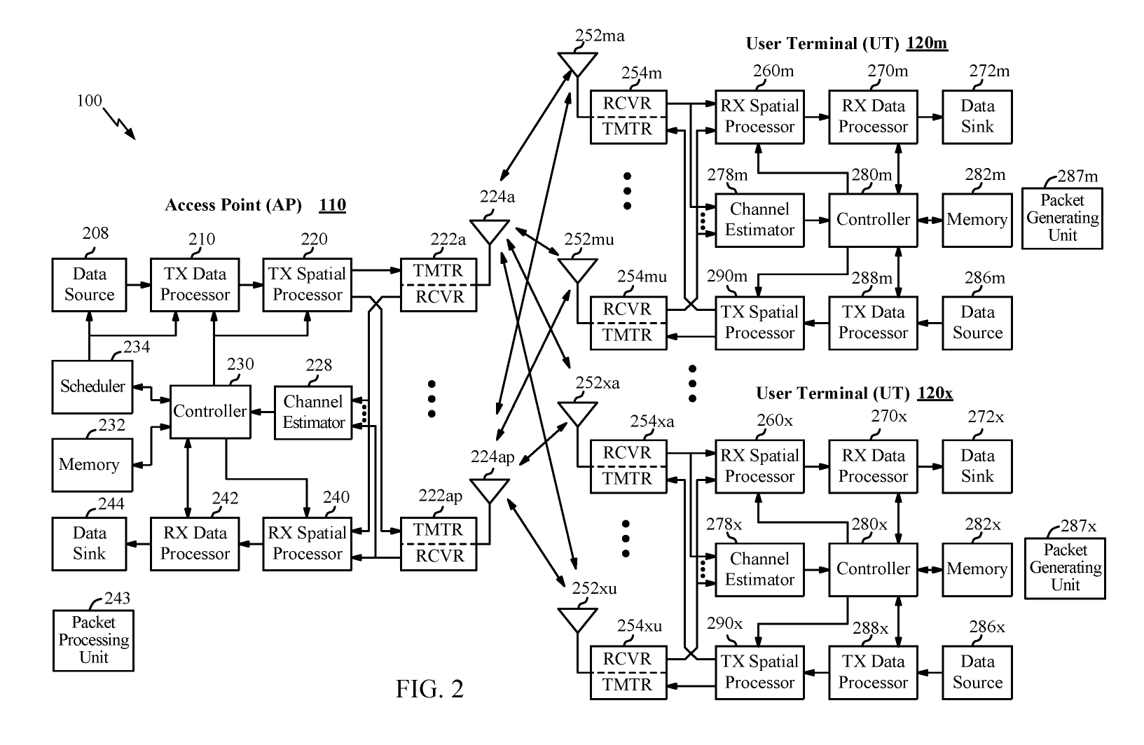

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

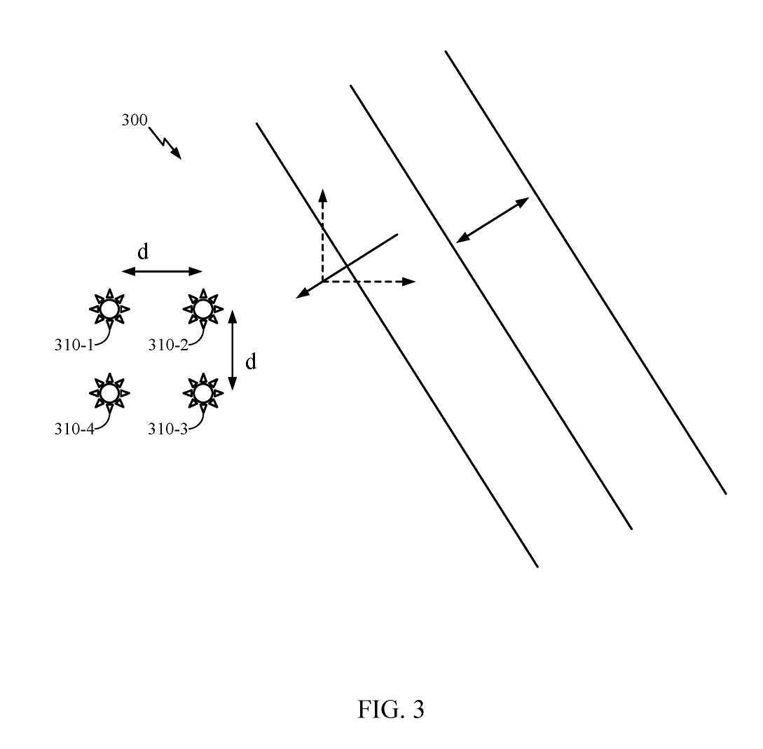

As illustrated, in FIGS. 1 and 2, one or more user terminals 120 may send one or more High Efficiency WLAN (HEW) packets 150, with a preamble format as described herein (e.g., in accordance with one of the example formats shown in FIGS. 3A-3B), to the access point 110 as part of a UL MU-MIMO transmission, for example. Each HEW packet 150 may be transmitted on a set of one or more spatial streams (e.g., up to 4). For certain aspects, the preamble portion of the HEW packet 150 may include tone-interleaved LTFs, subband-based LTFs, or hybrid LTFs (e.g., in accordance with one of the example implementations illustrated in FIGS. 10-13, 15, and 16).

The HEW packet 150 may be generated by a packet generating unit 287 at the user terminal 120. The packet generating unit 287 may be implemented in the processing system of the user terminal 120, such as in the TX data processor 288, the controller 280, and/or the data source 286.

After UL transmission, the HEW packet 150 may be processed (e.g., decoded and interpreted) by a packet processing unit 243 at the access point 110. The packet processing unit 243 may be implemented in the process system of the access point 110, such as in the RX spatial processor 240, the RX data processor 242, or the controller 230. The packet processing unit 243 may process received packets differently, based on the packet type (e.g., with which amendment to the IEEE 802.11 standard the received packet complies). For example, the packet processing unit 243 may process a HEW packet 150 based on the IEEE 802.11 HEW standard, but may interpret a legacy packet (e.g., a packet complying with IEEE 802.11a/b/g) in a different manner, according to the standards amendment associated therewith.

Certain standards, such as the IEEE 802.11ay standard currently in the development phase, extend wireless communications according to existing standards (e.g., the 802.11ad standard) into the 60 GHz band. Example features to be included in such standards include channel aggregation and Channel-Bonding (CB). In general, channel aggregation utilizes multiple channels that are kept separate, while channel bonding treats the bandwidth of multiple channels as a single (wideband) channel.

As described above, operations in the 60 GHz band may allow the use of smaller antennas as compared to lower frequencies. While radio waves around the 60 GHz band have relatively high atmospheric attenuation, the higher free space loss can be compensated for by using many small antennas, for example arranged in a phased array.

Using a phased array, multiple antennas may be coordinated to form a coherent beam traveling in a desired direction. An electrical field may be rotated to change this direction. The resulting transmission is polarized based on the electrical field. A receiver may also include antennas which can adapt to match or adapt to changing transmission polarity.

FIG. 3 is a diagram illustrating signal propagation 300 in an implementation of phased-array antennas. Phased array antennas use identical elements 310-1 through 310-4 (hereinafter referred to individually as an element 310 or collectively as elements 310). The direction in which the signal is propagated yields approximately identical gain for each element 310, while the phases of the elements 310 are different. Signals received by the elements are combined into a coherent beam with the correct gain in the desired direction.

### Example Beamforming Training Procedure

In high frequency (e.g., mmWave) communication systems which may be implemented using IEEE standards such as 802.11ad and 802.11ay), beamforming (BF) may be used with phased array antennas on both receive and transmit sides in order to achieve good communication link. As described above, beamforming (BF) generally refers to a mechanism used by a pair of STAs to adjust transmit and/or receive antenna settings to achieve a desired link budget for subsequent communication.

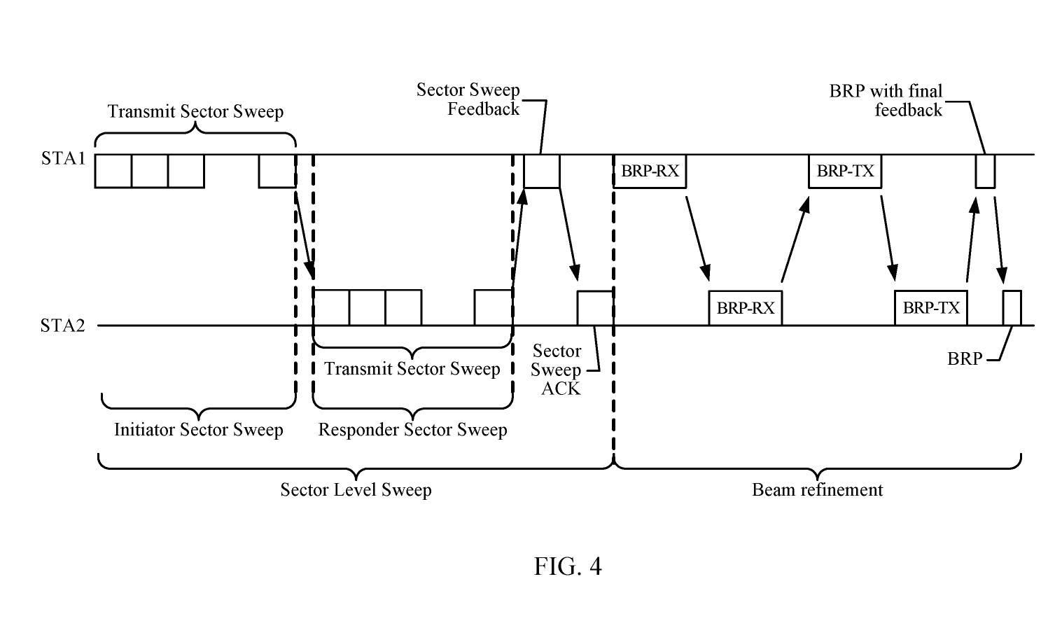

As illustrated in FIG. 4, BF training may involve a bidirectional sequence of BF training frame transmissions between STAs that uses a sector sweep followed by a beam refining phase (BRP). For example, an AP or non-AP STA may initiate such a procedure to establish an initial link. During the sector sweep, each transmission is sent via a different sector identified in the frame and provides the necessary signaling to allow each STA to determine appropriate antenna system settings for both transmission and reception. Each sector may correspond to a different directional beam having a certain width.

As illustrated in FIG. 4, in all cases where the AP has a large number of elements, the sectors used are relatively narrow, causing the SLS process to take long time. With higher the directivity, more sectors may be used, and therefore, the SLS may be longer. As an example, an AP with an array of a hundred antenna elements may use a hundred sectors. This scenario is not desired since SLS is an overhead that affects throughput, power consumption and induces a gap in the transport flow.

Various techniques may be used to reduce throughput time. For example, short SSW (SSSW) messages may be used instead of the SSW messages, which may save some time (e.g., about 36%). In some cases, throughput may be reduced by using several RF chains for transmission. This facilitates transmission in parallel on several single channels and can shorten the scan by several factors. Unfortunately, this approach may require the receiver to support multiple frequency scans, and may not be backward compatible (e.g., with 802.11ad devices) and may require the stations to fully be aware of this special mode in advance. In some cases, the Tx SLS+Rx SLS or the Tx SLS+Rx BRP may be replaced with a new Tx+Rx BRP where only one “very” long BRP message is used with many TRN units. Unfortunately, this method requires a very long message but may be able to support multiple STAs in parallel, making it efficient but only in cases with a large number of STAs.

### Example Technique for Bi-Static Radar Operation Simultaneously with an Active Mmwave Link

Current mmWave devices use beamforming to overcome path-loss in order to efficiently communicate. During link establishment, the mmWave devices may send messages in multiple directions with the intention that the intended receiver will receive the transmission in at least one of the directions. Generally, there are two approaches for beamforming, one is a sector level sweep (SLS) protocol where a transmitter sends a PPDU for each direction, and the second is a beam-refinement phase (BRP-TX) protocol, where a transmitter can send one PPDU, but with preceding pilot sequences, each pilot sequence directed to different direction.

In addition, there exists mmWave devices that allow full-duplex operation. These devices usually allow one antenna(s) to transmit while the other antenna(s) are receiving. Certain aspects of the present disclosure are generally directed to performing bi-static radar operations, where one antenna (or an antenna array) transmits signals in different directions, while another antenna (or antenna array) receives signals that may have reflected off of objects to be detected. For example, in certain aspects of the present disclosure, a wireless node may perform beamforming by using some of its antennas as receive antennas and some of its antennas as transmit antennas. The wireless node may then process the received signals during the transmitted beamforming (either SLS or BRP-TX).

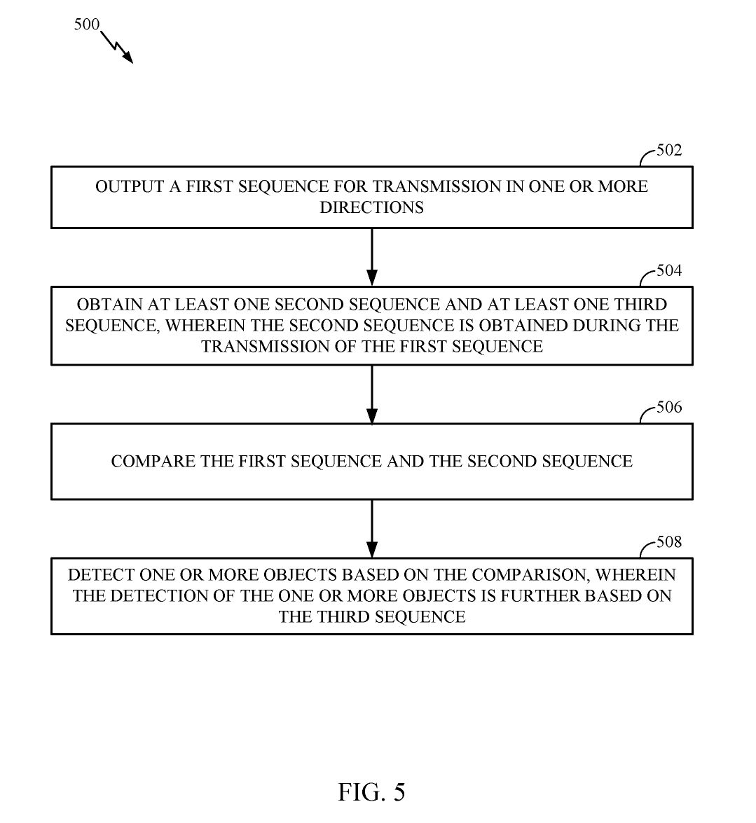

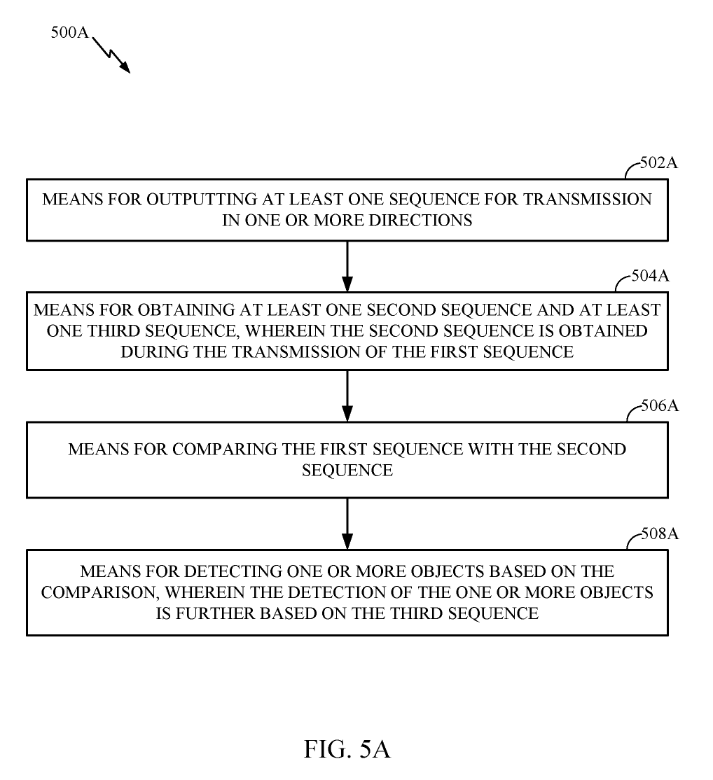

FIG. 5 illustrates example operations 500 for wireless communication, in accordance with certain aspects of the present disclosure. The operations 500 may be performed by a wireless node, for example, by an AP or a non-AP station (STA).

The operations 500 begin, at block 502, by outputting (e.g., via a first antenna array) at least one first sequence (e.g., Golay sequences) for transmission in one or more directions, and at block 504, obtaining (e.g., via a second antenna array) at least one second sequence, wherein the second sequence is obtained during the transmission of the first sequence. For example, the wireless node may be full-duplex capable, allowing for the transmission of the first sequence via a first antenna array while receiving a second sequence (e.g., the reflection of the first sequence) via a second antenna array. In certain aspects, the wireless node may also receive a third sequence. At block 506, the wireless node compares the first sequence with the second sequence, and at block 508, detects one or more objects based on the comparison. In certain aspects, the detection of the one or more objects may be further based on the third sequence.

In certain aspects, the comparison at block 506 may include performing a cross-correlation (CC) of the at least one first sequence and the at least one second sequence. In this case, the detection may be based on the CC results. For example, the CC may be performed to detect reflections and scatters surrounding the wireless node. These reflections may appear as a new tap in the CC output. The wireless node may generate, based on the CC results, a table including a distance, angle, material classification, and speed for each target (e.g., detected object), as described in more detail herein.

In certain aspects, a distance (D) of the detected one or more objects may be determined by measuring a round trip time for the reflecting wave (e.g., the at least one second sequence) to return to the receiving antenna of the wireless node. The distance D may be calculated based on the equation:

$$D = T \frac{C}{2}$$

where C is the speed of light, and T is the round trip time. For example, the round trip time may be the time difference between the transmission of the first sequence and the reception of the second sequence (e.g., reflection of the first sequence).

In certain aspects, the relative speed of the object may be determined by measuring a phase offset (PO) (e.g., phase difference) between the transmitted sequence (e.g., first sequence) and the received sequence (e.g., the at least one second sequence). The phase offset PO may be equal to a frequency offset (FO) multiplied by the round trip time T. The frequency offset FO may be the difference between the frequency of the at least one first sequence and the frequency of the at least one second sequence (e.g., the reflection of the first sequence). The frequency offset F may be determined based on the Doppler shift which corresponds to the speed of the detected object relative to the transmitter. The phase offset PO and the frequency offset FO may be determined based on the equations:

$$PO = 2 π \frac{S}{C} \times Fc \times T$$

$$FO = 2 π \frac{S}{C} \times Fc$$

where S is the speed of the object to be detected relative to the transmitter, C is the speed of light, Fc is the carrier frequency, and T is the round trip time.

In certain aspects, the reflection of the first sequence may be used to determine a material classification of the detected objection. For example, the material classification may be determined by measuring the amplitude of the reflected sequence (e.g., the received second sequence) off the detected object. For instance, metal materials may reflect signals with higher energy, corresponding to higher amplitudes, as compared to human skin or wood. Thus, based on the amplitude of the reflection, the material classification of the object may be determined.

In certain aspects, a direction of the detected object relative to the wireless node may be determined based on at least one of a transmission pattern of the first sequence or a reception pattern of the second sequence (the reflection). For example, a direction of the one or more objects with respect to the wireless node may be determined by simultaneously receiving the sequence (reflection) via multiple antenna arrays having different receive patterns (e.g., different antenna elements). For example, as presented above, at least one third sequence may be received which may be another reflection of the first sequence, in addition to the second sequence, off of the same object. In this case, the second and third sequences may be received using different antenna arrays having different antenna patterns (e.g., different active antenna elements) and/or having different phase responses. Thus, the correlation of the second sequence and the third sequence may be used to determine a direction of the detected object. In certain aspects, the phase information of the received sequence(s) (e.g., reflection(s)) may be compared with the transmitted sequence (e.g., first sequence outputted for transmission at block 502) to determine the direction of the one or more objects with respect to the wireless node.

In some cases, the phase difference of signals received by different antennas may be compared to the phase difference expected from each direction. For example, for a boresight object, the phase difference between the antennas may be close to zero since the wave front is parallel to the antenna array. In certain aspects, the direction of the one or more objects with respect to the wireless node may be determined based on a distance between the different antennas used to receive the reflections (e.g., the second sequence and the third sequence as described with respect to FIG. 5). For example, the distance between the different antennas may be determinative of the phase difference between the received reflections depending on the direction of the detected object. For instance, the phase of the reflection may correspond to the distance multiplied by the sine of the direction (e.g., angle relative to the wireless node) of the object.

In certain aspects, a direction of the one or more objects with respect to the wireless node may be determined by repeating the transmission of the first sequence while receiving via different antenna elements and/or antenna patterns. For example, the operations 500 may also include transmitting a fourth sequence, where the obtained third sequence as described with respect to FIG. 5 is a reflection of the fourth sequence off of an object. The phase information of the received sequences (e.g., the second and third sequences) may be compared with the transmitted sequence(s) (e.g., the at least one first sequence) to determine the direction of the one or more objects with respect to the wireless node.

Once the one or more objects are detected as described herein, one or more actions may be taken by the wireless node. For example, in some cases, the wireless node may use the information regarding the detected objects to adjust transmission patterns to improve communication efficiency. In some cases, the one or more objects may be reported to a user or an application operating on the wireless node.

In certain aspects, the at least one first sequence as described with respect to FIG. 5 may be part of a beam refinement protocol (BRP) frame. For example, the operation at block 502 may include outputting a BRP frame for transmission where the BRP frame comprises the first sequence. For instance, each of the at least one first sequence may be part of a different training field of the BRP frame.

In some cases, the at least one first sequence as described with respect to FIG. 5 may be part of one or more sector level sweep (SLS) frames. For example, the operation at block 502 may include outputting for transmission one or more SLS frames (e.g., PPDUs). In this case, each of the SLS frames may include a different one of the at least one first sequence. For instance, each of the one or more first sequences may be part of a short training field and/or a channel estimation field of the sector level sweep frames.

While the BRP and SLS frames are provided as example types of frames that may include the at least one first sequence to facilitate understanding, the at least one first sequence may be included in any type of frame (e.g., in accordance with any standard). For example, the first sequence may be included in a frame with or without data. In some cases, a frame including at least one of a channel estimation field or a training field, where the at least one of the channel estimation field or the training field may include the first sequence. Certain aspects of the present disclosure allow for seamless operation of radar during mmWave signal transmissions with little to no effect on the active link.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500 illustrated in FIG. 5 correspond to means 500 A illustrated in FIG. 5A.

For example, means for exchanging may comprise a transmitter (e.g., the transmitter unit 222) and/or an antenna(s) 224 of the access point 110 or the transmitter unit 254 and/or antenna(s) 252 of the user terminal 120 illustrated in FIG. 2 and/or a receiver (e.g., the receiver unit 222) and/or an antenna(s) 224 of the access point 110 or the receiver unit 254 and/or antenna(s) 252 of the user terminal 120 illustrated in FIG. 2. Means for causing, means for comparing, means for determining, means for detecting, or means for generating may comprise a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the user terminal 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a first interface configured to output at least one first sequence for transmission in one or more directions;
a second interface configured to obtain at least one second sequence and at least one third sequence, wherein the at least one second sequence is obtained during the transmission of the at least one first sequence; and
a processing system configured to:
compare the at least one first sequence with the at least one second sequence; and
detect one or more objects based on the comparison, wherein the detection of the one or more objects is further based on the at least one third sequence.

2. The apparatus of claim 1, wherein:
the processing system is configured to compare a phase of the at least one second sequence with a phase of the at least one third sequence; and
the processing system is further configured to detect a direction of the one or more objects relative to the apparatus based on the comparison of the phases of the at least one second sequence and the at least one third sequence.

3. The apparatus of claim 2, wherein:
the second interface is configured to obtain the at least one second sequence and the at least one third sequence via different antennas; and
the processing system is further configured to detect the direction based on a distance between the different antennas.

4. The apparatus of claim 1, wherein:
the first interface is configured to output at least one fourth sequence for transmission in one or more directions, wherein the at least one third sequence is obtained during the transmission of the fourth sequence;
the processing system is configured to compare a phase of the at least one second sequence with a phase of the at least one third sequence; and
the processing system is configured to detect a direction of the one or more objects relative to the apparatus based on the comparison of the phases of the at least one second sequence and the at least one third sequence.

5. The apparatus of claim 4, wherein a transmission pattern of the at least one first sequence is different than a transmission pattern of the at least one fourth sequence.

6. The apparatus of claim 4, wherein:
the second interface is configured to obtain the at least one second sequence and the at least one third sequence via different antennas; and
the processing system is further configured to detect the direction based on a distance between the different antennas.

7. The apparatus of claim 1, wherein:
the comparison comprises performing a cross-correlation of the at least one first sequence and the at least one second sequence; and
the detection is based on the cross-correlation.

8. The apparatus of claim 1, wherein the processing system is configured to detect a distance between the apparatus and the one or more objects based on the comparison.

9. The apparatus of claim 8, wherein:
the processing system is configured to determine an amount of time between the transmission of the at least one first sequence and reception of the at least one second sequence; and
the detection of the distance is based on the amount of time.

10. The apparatus of claim 1, wherein the processing system is configured to detect a direction of the one or more objects relative to the apparatus based on the comparison.

11. The apparatus of claim 10, wherein the detection of the direction is based on at least one of a transmission pattern of the at least one first sequence or a reception pattern of the at least one second sequence.

12. The apparatus of claim 1, wherein the processing system is configured to detect a material classification of the one or more objects based on the comparison.

13. The apparatus of claim 12, wherein:
the processing system is configured to determine an amplitude of the at least one second sequence; and
the detection of the material classification is based on the amplitude.

14. The apparatus of claim 1, wherein the processing system is configured to detect a speed of the one or more objects relative to the apparatus based on the comparison.

15. The apparatus of claim 14, wherein:
the processing system is configured to determine a phase offset between the at least one first sequence and the at least one second sequence; and
the detection of the speed is based on the phase offset.

16. The apparatus of claim 1, wherein:
the processing system is configured to generate a frame, wherein the frame comprises the at least one first sequence; and
the first interface is configured to output the frame for transmission.

17. The apparatus of claim 16, wherein the frame comprises at least one of a channel estimation field or a training field, wherein the at least one of the channel estimation field or the training field comprises the at least one first sequence.

18. The apparatus of claim 1, wherein:
the processing system is configured to generate at least one sector level sweep frame, wherein the sector level sweep frame comprises the at least one first sequence; and
the first interface is configured to output the at least one sector level sweep frame for transmission.

19. The apparatus of claim 1, wherein:
the processing system is configured to generate a beam refinement protocol frame, wherein the beam refinement protocol frame comprises the at least one first sequence; and
the first interface is configured to output the beam refinement protocol frame for transmission.

20. The apparatus of claim 1, wherein the at least one first sequence comprises at least one Golay sequence.

21. The apparatus of claim 1, wherein:
the first interface is configured to output the at least one first sequence via a first antenna array; and
the second interface is configured to obtain the at least one second sequence via a second antenna array.

22-64. (canceled)

65. A wireless node, comprising:
at least one first antenna array;
at least one second antenna array;
a first interface configured to output at least one first sequence for transmission in one or more directions via the first antenna array;
a second interface configured to obtain at least one second sequence via the second antenna array and configured to obtain at least one third sequence, wherein the at least one second sequence is obtained during the transmission of the at least one first sequence; and
a processing system configured to:
compare the at least one first sequence with the at least one second sequence; and
detect one or more objects based on the comparison, wherein the processing system is further configured to detect the one or more objects based on the at least one third sequence.
